(19) United States
(12) Patent Application Publication
(10) Pub. No.: US 2006/0078178 A1
(43) Pub. Date: Apr. 13, 2006

(54) Swipe sensor

(76) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/224,802

(22) Filed: Sep. 13, 2005

Related U.S. Application Data
(60) Provisional application No. 60/610,684, filed on Sep. 18, 2004.

(51) Int. Cl. G06K 9/00

(52) U.S. Cl. 382/124

(57) ABSTRACT

A sensor for obtaining fingerprint images comprising a row of sensing elements for obtaining a plurality of snapshots of a fingerprint as a finger passes the sensor and at least one reference grid, wherein comparisons made upon images obtained from the reference grid are used to control the rate at which snapshots are obtained by the row of sensing elements.

### RELATED APPLICATIONS

The present invention claims priority to U.S. Provisional Application No. 60/610,684 filed on Sep. 18, 2004, which is fully incorporated herein by reference.

### FIELD

The present invention relates generally to the field of fingerprint analysis, and, more specifically, to an apparatus and process of obtaining fingerprint samples.

### BACKGROUND

Fingerprints have been widely used for many years as a means for identification or verification of an individual's identity. For many years, experts in the field of fingerprints would manually compare sample fingerprints to determine if two prints matched each other, which allowed for identification or verification of the person that created the fingerprint. In more recent times, fingerprint recognition has been improved by using computer analysis techniques developed to compare a fingerprint with one or more stored sample fingerprints.

Computer analysis of fingerprints has typically involved comparing a complete fingerprint against one or more known samples. In applications where the objective is to identify an individual from a fingerprint sample, the subject fingerprint sample is typically compared to a large volume of samples taken from many people. The volume of samples are typically stored in a database, and the subject print is compared to each fingerprint in the database to determine if there exists a match between the subject sample and any of the samples in the database. For example, a fingerprint sample obtained at a crime scene might be compared to fingerprints in a database containing fingerprints of individuals with prior criminal histories in an attempt to identify the suspect. In applications where the objective is to verify an individual from a fingerprint sample, the subject fingerprint is typically compared to a smaller number of fingerprint samples. For example, fingerprint verification may be used to allow access to a restricted area. A person's fingerprint is sampled and compared against known fingerprints of that individual. A match would indicate a verification of the individual's identity (i.e., that the individual providing the sample is, in fact, the individual whose fingerprints are contained in the database) and access would be allowed.

In many identification and/or verification processes, a fingerprint pad is typically used to obtain the subject sample. A fingerprint pad is typically a small square sensor, usually one-half inch by one-half inch in size, upon which a person places his or her finger. A single image of the person's complete fingerprint is taken, normally using some form of camera or imaging device. The captured image is typically digitized and stored as a digital image that can be compared to other stored images of fingerprints.

More recently, swipe sensors have been developed to obtain fingerprint samples. A swipe sensor is typically a thin, rectangular shaped device measuring approximately one-half inch by one-sixteenth inch. The swipe sensor obtains a number of small images, or snapshots, as a finger is swiped past the sensor. A complete fingerprint image is obtaining by processing these snapshots to form a composite image. The compiling of the smaller images into a complete fingerprint is typically referred to as “stitching” the images.

Several types of swipe sensors are currently used. One typical swipe sensor uses a high volume of small capacitors to create each snapshot. The sensor charges the capacitor and measures the rate of discharge caused by a fingerprint when a finger is passed over the sensor. Different fingerprint characteristics cause the capacitors to discharge at different rates. These sensors normally produce an 8-bit gray scale value for each pixel in the sensor, and typically has a resolution of 500 dots per inch (dpi). Another type of swipe sensor uses thermal characteristics to obtain the snapshots. These sensors measure temperature differences between ridges and valleys of a fingerprint as the finger is passed over the sensor. A third type of swipe sensor uses photodetectors to optically obtain the snapshot images. All of these sensor types are typically capable of providing a fingerprint image resolution of 500 dpi or more.

Processing fingerprints using a swipe sensor requires extensive computing resources. Powerful microprocessors, significant amounts of memory, and a relatively long processing time are required to adequately stitch the snapshots into complete images. A need exists for a means for obtaining and processing fingerprints that is more efficient, i.e., uses less computer resources and less time. The present invention fulfils this need, among others.

### SUMMARY

A sensor for obtaining fingerprint images is provide that comprises a row of sensing elements for obtaining a plurality of snapshots of a fingerprint as a finger passes the sensor and at least one reference grid. Comparisons made upon samples obtained from the reference grid are used to control the rate at which snapshots are obtained by the row of sensing elements.

Additional objects, advantages, and novel features of the invention will be set forth in part in the description, examples, and figures which follow, all of which are intended to be for illustrative purposes only, and not intended in any way to limit the invention, and in part will become apparent those skilled in the art on examination of the following, or may be learned by practice of the invention.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 illustrates an exemplary sensor in accordance with the present invention.

FIG. 2 illustrates an exemplary system for obtaining fingerprint images using the sensor of FIG. 1.

FIG. 3 is a flow chart illustrating the steps involved in obtaining a fingerprint image using a sensor in accordance with an exemplary embodiment of the present invention.

### DETAILED DESCRIPTION

Overview

Swipe sensors have been a preferred device for obtaining fingerprint samples in many applications. The swipe sensors that are typically used currently, however, function by obtaining several samples, or “snapshots” of a fingerprint, or portion thereof, when a finger is passed by the face of the swipe sensor. Once the snapshots are obtained, they are combined or “stitched” to form a complete fingerprint image.

The difficulty for each type of swipe sensor in the prior art lies in the combination of the snapshots into a complete print image. This task is typically performed by overlapping the edges of each snapshot, such that a complete print image can be accurately obtained. By aligning overlapping edges of each snapshot, the integrity of the overall print is maintained. The overlapping portions assure that there is no section of the print missing from the final compiled print image.

The need to overlap the snapshot images causes an increase in the required overhead (e.g., memory, hardware, processing resources) of the print imaging system. Additional memory is required to store the redundant data. Also, the complexity of the processing system needs to be increased to process a greater amount of data. Typical sensors use analog/digital (A/D) converters to convert the reading obtained by each pixel in the sensor (whether via capacitance, thermal, or optical detection), and then use a series of multiplexers to combine the data into a format that can be processed by a microprocessor. In addition to an increased number of A/D converters and multiplexers, additional processing is required to stitch the images and eliminate the redundant data.

Single Line Senor

The sensor in accordance with the present invention reduces or eliminates data redundancy, thus reducing the need for additional processing hardware in a print imaging system. While an exemplary embodiment is discussed herein with reference solely to fingerprints, it should be noted that exemplary embodiment is applicable to all types of prints, including thumbprints, toe prints, palm prints, etc.

Typical fingerprint matching techniques rely on extracting and identifying many features of a fingerprint. These features include ridge spacing and minutia locations, features which need to be identified within a fingerprint, and then compared to one or more samples to perform the matching process. The sensor in accordance with an exemplary embodiment of the present invention identifies when the fingerprint features change during the swipe process and uses the change in these features to determine sampling frequency.

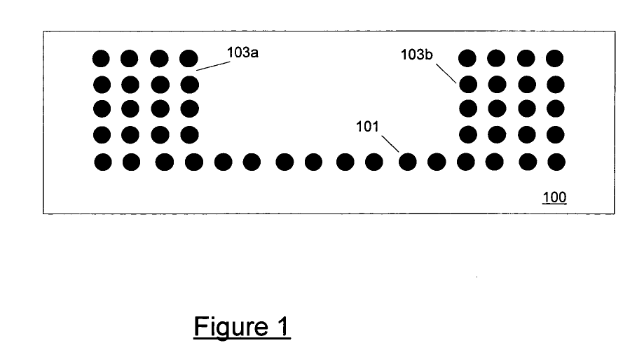

Referring to FIG. 1, an exemplary embodiment of the sensor 100 for use in conjunction with a swipe sensor imaging system is shown. A single row 101 of sensing elements resides on the sensor. The sensing elements typically comprise a single row of at least 200 pixels at 500 dpi resolution, although other sized rows and other resolutions may be used. The row of sensing elements is typically capable of being sampled at a rate of approximately 4000 times per second, although the actual rate at which samples will be read and stored from the single row 101 will be determined as described below.

Adjacent to the single row 101 is at least one reference grid 103a, 103b. In the embodiment illustrated in FIG. 1, two reference grids are shown and will be described. It is understood, however, that the invention may in the alternative be practiced using a single reference grid, or additional (3 or more) reference grids. Each of the reference grids 103a, 103b, comprises a small area of sensing elements positioned in close proximity to the single row 101 of sensing elements. In the exemplary embodiment, each reference grid 103a, 103b comprises a 4 pixel by 4 pixel grid. It is, however, understood that a reference grid can comprise various numbers of columns and rows. The reference grids 103a, 103b are sampled at a rate much higher than the single row 101. Typically, the reference grids 103a, 103b will be sampled at a rate of approximately eight times the rate used to sample the single row 101 (e.g., 32,000 per second). Each time the reference grids 103a, 103b are sampled, a current sample image (“current image”) is obtained from each grid. This current image is compared with a previously sampled reference image (“reference image”) obtained from the same grid that has been stored in memory. The comparison is used to determine if a user's finger has passed a sufficient distance past the sensor 100 such that a snapshot obtained from the single row 101 of sensor elements would provide an image of a portion of the fingerprint that has not yet been imaged (i.e., a snapshot would not provide duplicative or overlapping data). For example, if the current image from a reference grid 103a, 103b is within a certain predetermined similarity of the reference image, new snapshots from the single row 101 of sensing elements are not read or stored because the similarity of the images from the reference grid 103a, 103b indicates that a snapshot taken from the single row 101 of the sensor would provide duplicative data (i.e., the user's finger has not passed a sufficient distance in front of the sensor for a second distinct snapshot to be obtained). Alternatively, the reference image can be shifted a predetermined amount when it is stored to memory. In this case, the current image is compared to see if it matches the reference image, and a match indicates that the user's finger has moved an amount approximately equal to the shift applied to the reference image. This technique is further described below. Once the images from the reference grids 103a, 103b indicate sufficient movement of the user's finger, an additional sample image is read from the single row 101.

In an exemplary embodiment, the comparison of the current image and the reference image from the reference grids 103a, 103b involves using a shifting and matching technique. For example, a first sample image is read from the reference grids 103a, 103b. The first sample image comprises an array of pixel data that corresponds to the size of the reference grids 103a, 103b (e.g., 4×4 pixels). The first sample image is shifted one row down (i.e., in the direction of motion of the finger past the sensor pad). The bottom row of data is discarded, and the top row of data is empty. The shifted image is stored in a memory as the reference image. As the reference grids 103a, 103b are continually sampled at a high rate, each subsequently sampled image (i.e., the current image) is compared to the reference image. The comparison is made without consideration of the empty row of data (i.e., only the bottom three rows in a sample from a 4×4 grid are considered). Various comparison techniques may be used depending upon the type of sensor technology employed by the reference grid (e.g., capacitive, thermal, optical, etc.). Typically, however, a match is found when a current image contains data from all considered pixels that is within plus or minus 10% of the data in the reference image for each corresponding pixel. It is understood, however, that other sensitivity ranges could also be used.

If a match is determined to exist between the current image and a reference image, it is indicative that the user's finger has moved past the sensor for a distance that is approximately equal to the distance between the rows of pixels in the reference grid 103a, 103b. As a result, this is indicative that a snapshot should be taken from the single row 101 of sensor elements in order to maintain a continuous image of fingerprint of the user's finger. Once another snapshot is obtained from the single row 101 of sensor elements, a new first sample image from the reference grids 103a, 103b is shifted by one row and stored in the memory as a new reference image. This process can be repeated until a complete image of the user's fingerprint is obtained.

While the embodiment described herein uses a single row 101 of sensing elements, it should be appreciated that other embodiments can utilize sensor pads that contain more than a single line. A single line of sensing elements provides advantages such as reducing the amount of data that is captured and output from the sensor pad at a given time, thus reducing the amount of overhead required in the form of processing circuitry (e.g., A/D converters, multiplexers).

Additionally, the reference grid or grids can be of varying sizes, provided that enough resolution can be obtained to identify the change in print characteristics. The reference grids 103a, 103b need not utilize the same technology for obtaining print characteristics as the single line 101 sensor elements. For example, a swipe sensor might utilize a row of capacitors to form the single line 101, but photodiodes could be used to create the reference grid 103.

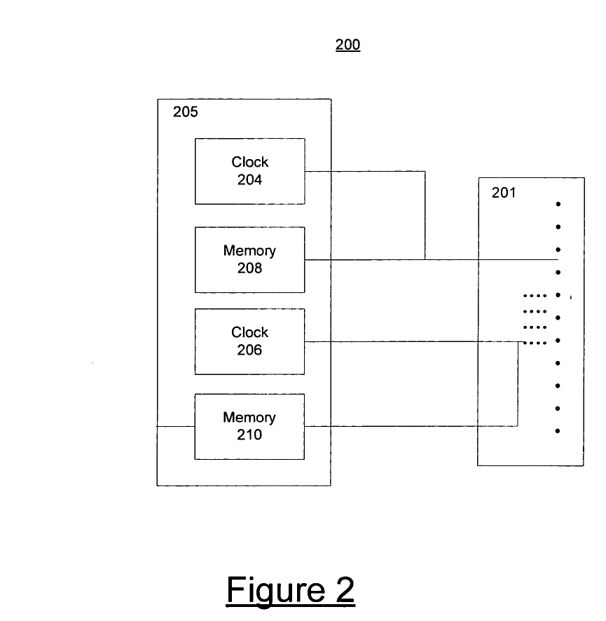

Referring to FIG. 2, an exemplary system employing a swipe sensor in accordance with present invention is shown. Swipe sensor system 200 comprises a sensor 201 having a single line 101 of sensor elements and a single reference grid 103. The sensor 201 is coupled to a microprocessor 205. The exemplary microprocessor contains a first clock 204 and a second clock 205. The first clock 204 drives the single line 101 of sensor elements. The second clock 205 drives the reference grid 103. During use, an image from the reference grid 103 is stored in a memory 208 as a reference image. A current image from the reference grid 103 is then compared to the reference image. A difference between the current image and the reference image is indicative that the user's finger has moved a sufficient amount past the senor 201. This indicates that a snapshot from the single line 101 of sensor elements would not be duplicative of a prior snapshot taken from the single line 101.

Upon detecting such a difference in images taken from the grid 103, a snapshot is taken from the single line 101 of sensing elements. The snapshot from the single row 101 can be output directly to a processing unit which compiles the snapshots into a complete image. Alternatively, the snapshots may be stored in a memory buffer 210 on the sensor system 200. Several snapshots can be stored and output together as a print image.

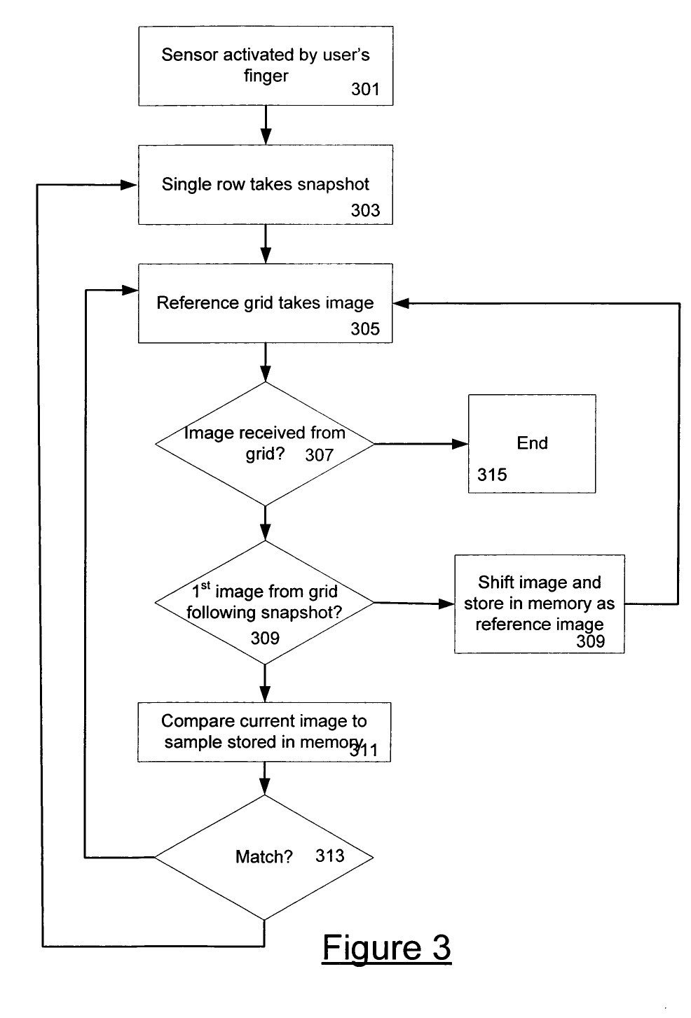

Referring to FIG. 3, a flowchart illustrating the steps involved in obtaining a fingerprint image in accordance with an exemplary embodiment of the present invention. To begin the process, a sensor in accordance with the present invention is activated (step 301). Activation can occur in several ways, such as a manual activation or automatic sensing of a user's finger. Such ways are well known to one of skill in the art, and do not need to be described herein to practice the present invention. Once a user's begins to swipe his or her finger across the swipe sensor, the single row of sensing elements obtains a snapshot (Step 303). The obtained snapshot can be stored in a memory or buffer to be output once the entire print has been obtained, or, alternatively, the snapshot can be output to a remote microprocessor where any further processing can occur. Once a snapshot has been taken by the single row of sensing elements, the reference grid is sampled (step 305). A determination is made to see if the image taken from the reference grid is the first image taken following a snapshot being obtained by the single row of sensor elements (step 309). If the image from the reference grid is the first image taken following a snapshot being obtained by the single row of sensor elements, it will become the image that used for comparison to later samples (i.e., reference image). In this event, the image obtained from the reference grid is shifted downward one row of pixels and stored in a memory (step 310) to be used as the reference sample for later comparison.

If the image is not the first image taken following a snapshot being obtained by the single row of sensor elements, then a reference image already exists in memory. In this case, the current image is compared with the reference image (step 311). If a match exists (step 313), it is indicative that the user's finger has advanced past the sensor a distance equal to the distance between one row of pixels. A new snapshot is taken by the single row of sensor elements (step 303). If a match is not present, the current image from the reference grid is discarded and a new image is taken (step 305).

This process is repeated until a sufficient number of snapshots to form a fingerprint image have been obtained. In one embodiment, the reference grid can indicate when the subject print is no longer present in front of the sensor, e.g., no image data indicative of a portion of a fingerprint is read during sampling (step 307). At this point, the print imaging process is terminated (step 315).

Using a swipe sensor in accordance with the present invention allows for the elimination of duplicative data from the data output from the sensor. This allows for simplification of the processing required to build a complete print image. This further allows for obtaining fingerprint images in a manner that requires less hardware and less computing resources than that typically required with prior swipe sensors. A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A sensor comprising:
a row of sensing elements for obtaining a plurality of snapshots of a fingerprint as a finger passes the sensor; and
at least one reference grid adjacent to said row,
wherein a plurality of images obtained from said at least one reference grid controls the rate at which snapshots of the fingerprint are obtained by the row of sensing elements.

2. The sensor as set forth in claim 1, wherein said row of sensing elements comprises a single row of pixels.

3. The sensor as set forth in claim 1, wherein said at least one reference grid comprises a grid of four pixels by four pixels.

4. The sensor as set forth in claim 1, further comprising a memory.

5. The sensor as set forth in claim 4, wherein said snapshots are stored in said memory.

6. The sensor as set forth in claim 4, wherein a first image from said plurality of images from said reference grid is stored in said memory as a reference image.

7. The sensor as set forth in claim 6, wherein a current image from said plurality of images from said reference grid is compared to said reference image to determine when said snapshots is read by said row of sensing elements.

8. The sensor as set forth in claim 7, wherein said snapshot is read by said row of sensing elements when said current image is determined to match, to within a predetermined tolerance, said reference image.

9. The sensor as set forth in claim 8, wherein said tolerance is plus or minus ten percent.

10. The sensor as set forth in claim 8, wherein said match is determined by shifting said first image downward by one row of pixels, causing a bottom row of data in said first image to be discarded and an empty row of data to be added to said first image;
storing said shifted first image as said reference image; and
comparing said reference image to said current image by comparing only corresponding rows containing data.

11. The sensor as set forth in claim 1, further comprising a microprocessor for compiling said plurality of snapshots into a fingerprint image.

12. A method for obtaining a fingerprint image comprising:
reading a first snapshot from a row of sensing elements;
reading a first image from a reference grid;
storing said first image in said memory as a reference image;
reading a second image from said reference grid;
comparing said second image and said reference image; and
reading a second snapshot from said row of said sensing elements based on results of said comparing step.

13. The method as set forth in claim 12, further comprising:
storing said first snapshot and said second snapshot in said memory.

14. The method as set forth in claim 12, wherein said storing step further comprises:
shifting said first image by one row of pixels to create a shifted image;
storing said shifted image in said memory as said reference image.

15. The method as set forth in claim 14, wherein said shifting step further comprises:
discarding a bottom row of data from said first image; and
adding an empty top row to said shifted image.

16. The method as set forth in claim 15, wherein said comparing step further comprises:
identifying a row of data in said second image that corresponds to said empty top row of data in said reference image;
excluding said identified row in said comparing of said second image and said reference image.

17. The method as set forth in claim 16, wherein said reading a second snapshot step is performed when said second image is determined to match said reference image to within a predetermined tolerance.

18. The method as set forth in claim 17, wherein said tolerance is plus or minus ten percent.

19. The method of claim 12, further comprising repeating said reading, storing, and comparing steps until a plurality of snapshots representative of said fingerprint image has been obtained.

20. The method of claim 19, further comprising using a microprocessor to create a fingerprint image from said plurality of snapshots.
